(19) United States
(12) Patent Application Publication
(10) Pub. No.: US 2009/0307725 A1
(43) Pub. Date: Dec. 10, 2009

(54) METHOD FOR PROVIDING CONTENTS INFORMATION IN VOD SERVICE AND VOD SYSTEM IMPLEMENTED WITH THE SAME

(75) Inventors: Sung-Yong Lee, Wonjoo (KR); Jae-Chan Shim, Daejeon (KR); Ho-Young Song, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/375,458

(22) PCT Filed: Jul. 26, 2007
(86) PCT No.: PCT/KR07/03584

§ 371 Date: Mar. 5, 2009

(30) Foreign Application Priority Data
Jul. 28, 2006 (KR) 10-2006-0071554

(51) Int. Cl. H04N 5/445

(52) U.S. Cl. 725/44; 725/87

(57) ABSTRACT

Provided are a method for providing contents information in a video on demand (VOD) service and a VOD service system implemented with the same. The VOD service system includes a transmitting unit, a contents storing par, a contents producing unit, and a controlling unit. The transmitting unit receives a VOD service request from a VOD client through a network and transmits data corresponding to the request to the VOD client. The contents storing unit stores moving picture contents to be provided. The contents producing unit produces representative moving pictures each for the corresponding moving picture content and configures an initial screen obtained by combining the representative moving pictures together. The controlling unit transmits the initial screen including the representative moving pictures of the individual moving picture contents when the VOD client makes a request to provide a list of the moving picture contents to be provided through the transmitting unit.

### TECHNICAL FIELD

The present invention relates to a method for providing contents information in a video on demand (VOD) service that can help a user to select and watch desired moving picture content among various VOD moving picture contents by showing brief content of each of the moving picture contents to the user, and a VOD service system.

### BACKGROUND ART

VOD services, which are often called customized video services, are provided through cable or Internet networks. Service providers offer various pieces of video information including movies or news to end users who want to subscribe VOD services.

In current VOD services, a set-top-box (STB) is typically used to provide various contents, and users purchase and watch the selected content among VOD contents provided by contents servers. At this time, users select the content merely relying on contents information provided by the servers.

In particular, a method for easily checking contents provided by VOD servers is taught in Korean patent application no. 10-2006-0012977 by K. Y. Yu in the name of electric Program Guide Providing Device and Method for Video on Demand Service.

According to the introduced method in the aforementioned Korean patent application, a service information receiver that receives service information about video-based services is used to display the name of a selected service, dates of providing the selected service, and other detailed information. When a user subscribes a VOD service, the service information receiver receives still images and other related text information and displays the received contents on each designated schedule.

However, since the above method uses only one image related to video (moving picture) content, a user may have to read all of the provided texts to find out the contents. Also, information related to video (moving picture) content may not be effectively provided to users.

### DISCLOSURE OF INVENTION

### Technical Problem

Accordingly, the present invention is directed to a method for providing contents information in a VOD service and a VOD system implemented with the same that substantially obviates one or more problems due to limitations and disadvantages of the related art.

An object of the present invention is to provide a method for providing contents information in a VOD service that can give convenience to a user by providing VOD contents information in the form of representative moving pictures related to the entire content of the provided contents, and a VOD service system.

Another object of the present invention is to provide a method for providing contents information in a VOD service that allows a user to easily select desired moving picture content by offering a storyboard related to detailed content of each of the provided contents while providing a list of VOD contents in the form of moving pictures, and a VOD service system.

Further another object of the present invention is to provide a method for providing contents information in a VOD service that can provide contents information in various forms by combining a storyboard related to detailed content of each of the provided contents with an original sound track (OST) and text information corresponding to the storyboard while providing a list of VOD contents in the form of moving pictures, and a VOD service system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, a method for providing contents information in a VOD service and a VOD system implemented with the same are provided.

According to an aspect of the present invention, there is provided a VOD service system including: a transmitting unit receiving a VOD service request from a VOD client and transmitting data corresponding to the request to the VOD client through a network; a contents storing unit storing moving picture contents to be provided; a contents producing unit producing representative moving pictures each for the corresponding moving picture content stored on the contents storing unit and configuring an initial screen obtained by combining the representative moving pictures together; and a controlling unit transmitting the initial screen including the representative moving pictures of the individual moving picture contents produced at the contents producing unit when the VOD client makes a request to provide a list of the moving picture contents to be provided through the transmitting unit.

According to another aspect of the present invention, there is provided a method for providing contents information in a VOD service, the method including the steps of: receiving a list of moving picture contents to be provided from a VOD client; providing an initial screen displaying representative moving pictures each for the corresponding moving picture content to the VOD client; receiving a selection of the specific representative moving picture on the initial screen from the VOD client; and providing a detailed screen displaying detailed contents information on the selected specific representative moving picture.

It is to be understood that both the foregoing general description and the following detailed description of the present invention are exemplary and explanatory and are intended to provide further explanation of the invention as claimed.

### ADVANTAGEOUS EFFECTS

According to various embodiments of the present invention, a list and content of moving picture contents are represented using representative moving pictures and a storyboard. Thus, a user who wants to select and watch desired content can be provided with related contents information through various approaches that are visually and acoustically enhanced.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is configuration diagram of a VOD system to show a list and content of moving picture contents in a VOD service according to an embodiment of the present invention;

FIG. 2 is a functional block diagram of a contents producing unit according to an embodiment of the present invention;

FIG. 3 illustrates an initial screen that displays a list of moving picture contents using representative moving pictures in a VOD service according to an embodiment of the present invention;

FIG. 4 is a detailed block diagram of a moving picture processing unit according to an embodiment of the present invention;

FIG. 5 is a simplified block diagram illustrating sequential operations of producing a representative moving picture according to an embodiment of the present invention;

FIG. 6 is a functional block diagram of a contents producing unit according to another embodiment of the present invention;

FIG. 7 illustrates a detailed screen that displays the selected moving picture content by combining a storyboard with an OST and text information corresponding to the storyboard in a VOD service;

FIG. 8 is a detailed block diagram of a frame processing unit according to an embodiment of the present invention;

FIG. 9 is a simplified block diagram illustrating operations of producing a representative frame according to an embodiment of the present invention;

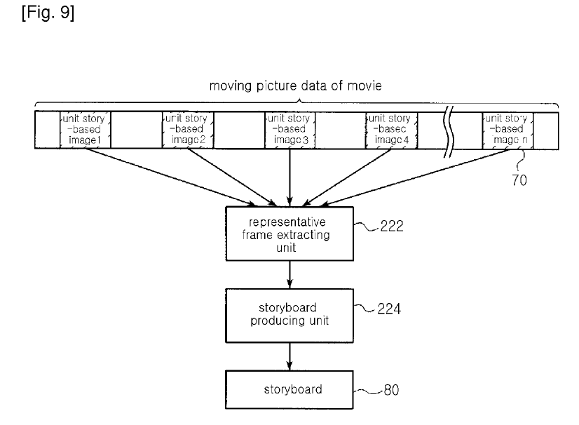

FIG. 10 illustrates exemplary cases of representing a plurality of representative frames that compose a storyboard in a VOD service in a predetermined order or in a sequential order according to an embodiment of the present invention;

FIG. 11 is a flowchart to illustrate a method for providing contents information in a VOD service according to an embodiment of the present invention;

FIG. 12 is a flowchart to illustrate sequential operations of producing an initial screen using representative moving pictures in a VOD service according to an embodiment of the present invention; and

FIG. 13 is a flowchart to illustrate sequential operations of producing a detailed screen using representative frames in a VOD service according to an embodiment of the present invention.

### BEST MODE FOR CARRYING OUT THE INVENTION

Reference will now be made in detail to the preferred embodiments of the present invention, examples of which are illustrated in the accompanying drawings.

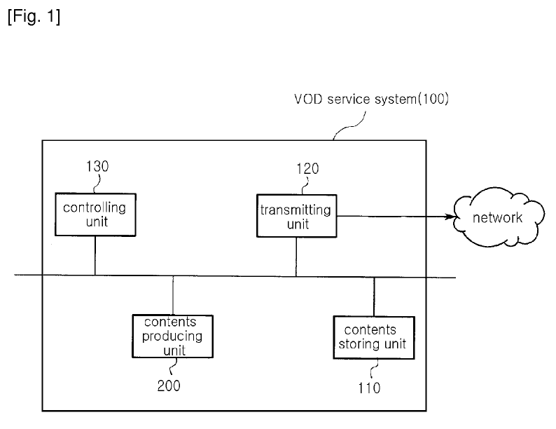

FIG. 1 illustrates a configuration diagram of a VOD service system 100 according to an embodiment of the present invention.

The VOD service system 100 includes a contents storing unit 110, a transmitting unit 120, a controlling unit 130, and a contents producing unit 200.

The contents storing unit 110 stores all of the moving picture contents to be provided.

The transmitting unit 120 receives a VOD service request from a VOD client and transmits data corresponding to the request to the VOD client through a network.

The controlling unit 130 transmits a list of the moving picture contents including the representative moving pictures for respective moving picture contents produced at the contents producing unit 200, when the VOD client makes a request to provide a list of the moving picture contents to be provided through the transmitting unit 120.

The contents producing unit 200 produces a representative moving picture for each of the moving picture contents stored on the contents storing unit 110.

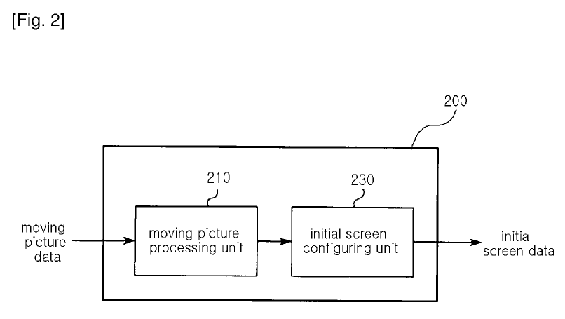

FIG. 2 is a detailed block diagram of the content producing unit 200 of FIG. 1 according to an exemplary embodiment of the present invention.

The contents producing unit 200 includes a moving picture processing unit 210 and an initial screen configuring unit 230.

The moving picture processing unit 210 separates data about the moving picture contents stored on the contents storing unit 110 into multiple unit story-based moving pictures on the basis of the data content and combines the separated unit story-based moving pictures together to produce one consecutive representative moving picture for each of the moving picture contents.

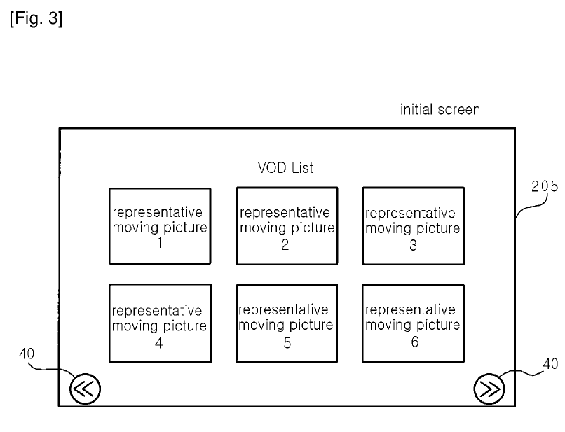

After the combination of the unit story-based moving pictures into the representative moving pictures for the respective moving picture contents at the moving picture processing unit 210, the initial screen configuring unit 230 outputs the individual representative moving pictures in the VOD service on one screen, i.e., an initial screen 205. The initial screen configuring unit 230 configures the initial screen 205 that displays a list of the moving picture contents as illustrated in FIG. 3.

As illustrated, the initial screen 205 shows a list of the moving picture contents using the representative moving pictures. Scroll bars 40 can be used to move the initial screen 205 to the left and right to search for the representative moving picture of the desired moving picture content.

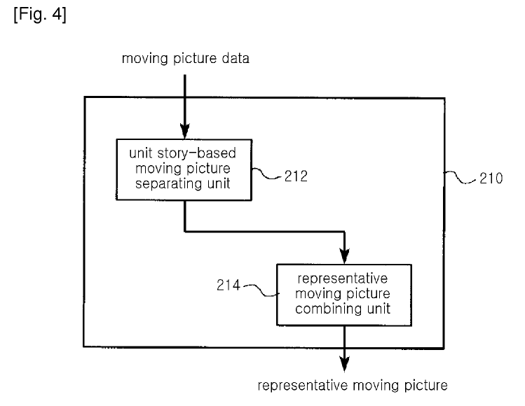

FIG. 4 is a detailed block diagram of the moving picture processing unit 210 of FIG. 1.

The moving picture processing unit 210 includes a unit story-based moving picture separating unit 212 and a representative moving picture combining unit 214.

The unit story-based moving picture separating unit 212 separates the moving picture contents into multiple unit story-based moving pictures based on the content of the moving picture contents through a certain editing activity.

The representative moving picture combining unit 214 combines the separated unit story-based moving pictures into one consecutive moving picture for each of the moving picture contents.

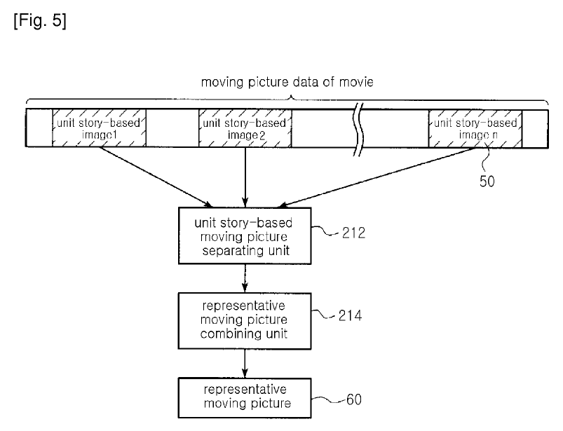

Accordingly as illustrated in FIG. 5, the moving picture processing unit 210 separates moving picture contents into unit story-based moving pictures, and then combines the unit story-based moving pictures into one consecutive representative moving picture for the corresponding moving picture content.

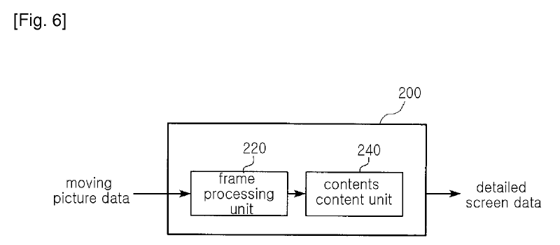

FIG. 6 is a detailed block diagram of the content producing unit 200 of FIG. 1 according to other embodiments of the present invention.

The contents producing unit 200 of the VOD service system 100 may further include a frame processing unit 220 and a contents content unit 240 except the moving picture processing unit 210 and the initial screen configuring unit 230.

The frame processing unit 220 extracts a plurality of representative frames from the moving picture contents, selects a predetermined number of the representative frames among the extracted representative frames, and then connects with each of the representative frames to produce one storyboard.

Each of the representative frames produced in one storyboard is sequentially played based on a predetermined order.

In here, the representative frame extraction may proceed with using a representative extraction algorithm well known in the multimedia summarization technology.

The contents content unit 240 configures a detailed screen of each of the moving picture contents using the storyboard produced at the frame processing unit 220. The contents content unit 240 combines an OST of the corresponding moving picture content and text information with each other in order to provide the detailed content of the corresponding moving picture content.

In more detail, although not illustrated, there is a database that stores information related to the moving picture contents provided to the contents content unit 240.

For instance, the database stores OST acting as identification assigned to each of the moving picture contents and text information (e.g., the title of a movie, main actors/actresses, a director, and a synopsis), and provides the corresponding OST and text information to the contents content unit 240 when the storyboard is produced.

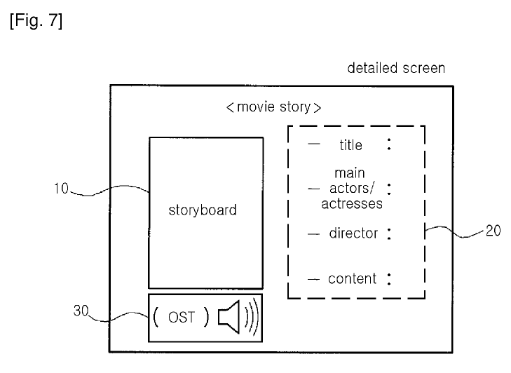

The contents content unit 240 combines the storyboard with the corresponding OST and text information with each other to produce the detailed screen. FIG. 7 illustrates the exemplary detailed screen.

In FIG. 7, reference numeral 10, 20 and 30 represent a storyboard region, a text information region and an OST providing region, respectively.

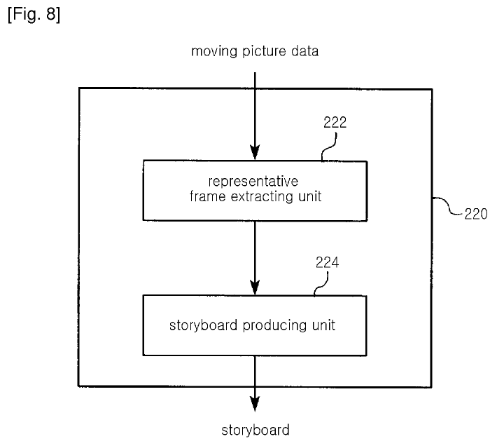

FIG. 8 is a detailed block diagram of the frame processing unit 220 of FIG. 6 according to an embodiment of the present invention.

The frame processing unit 220 includes a representative frame extracting unit 222 and a storyboard producing unit 224.

The representative frame extracting unit 222 extracts a plurality of representative frames from the moving picture contents and selects a predetermined number of the representative frames among the extracted representative frames.

More specifically, several sheets of still images (frames) that compose the moving picture content are necessary to produce the storyboard. The necessary still images can be provided by using a method of obtaining representative frames of moving picture content.

For instance, a method of finding out a point where a scene is switched by computing a pixel value difference between consecutive frames, a method of fining out a scene switching point by computing a histogram difference between consecutive frames, and a method of finding out a scene switching point by checking motions between consecutive frames can be used to provide the necessary still images.

The basic principle of the representative frame extraction is well known in the art, and thus, detailed description thereof will be omitted.

Since each of the moving picture contents includes many frames, the number of the frames is reduced to a predetermined number of the frames. The storyboard producing unit 224 may produce the finally determined number of the frames, i.e., the representative frames, in one file.

The storyboard producing unit 224 connects the extracted representative frames with each other to produce one consecutive storyboard.

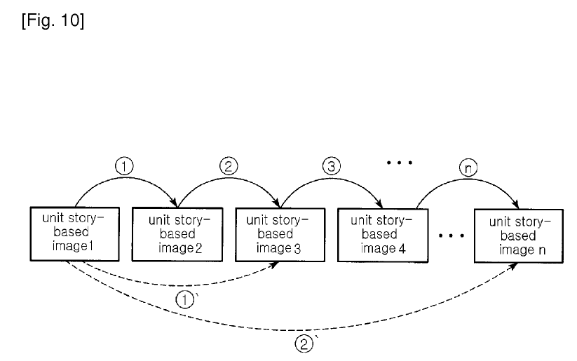

As illustrated in FIG. 10, the storyboard producing unit 224 plays each of the representative frames produced on the storyboard in a predetermined order or in a sequential order. That is, the representative frames may be sequentially played, or every odd number of the representative frames is selected and played.

In here, the storyboard is a collection of photographs composed of images, and represents a plurality of still images in a predetermined or sequential order on a preset spatial and temporal order basis.

At this time, when the individual representative frames produced in one storyboard are played sequentially, the first frame is played again after the last frame is played.

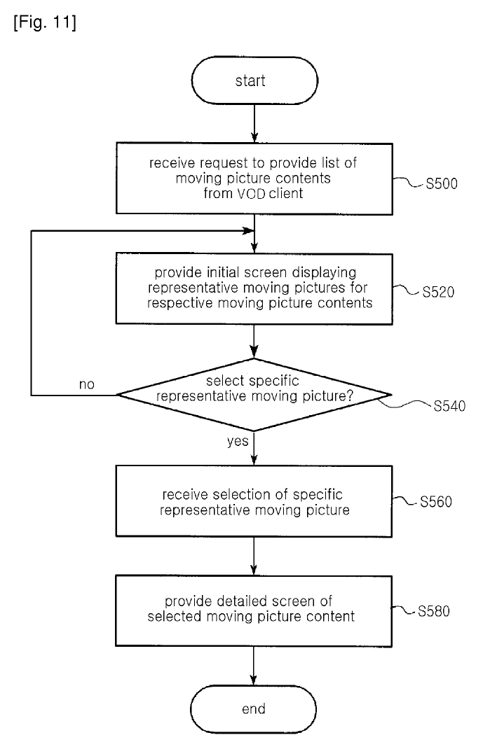

With reference to FIG. 11, sequential operations of providing VOD contents information in the VOD service system 100 will be described hereinafter.

FIG. 11 is an operational flowchart to represent VOD contents information in the VOD service according to an embodiment of the present invention.

In operation of S500, the VOD service system 100 receives a request to provide a list of moving picture contents from a VOD client.

In operation of S520, the VOD service system 100 provides an initial screen on which representative moving pictures of the respective moving picture contents are displayed.

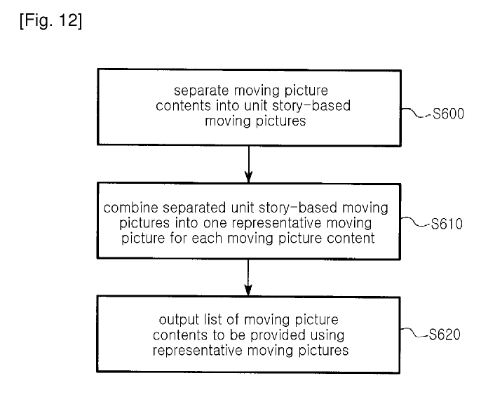

The initial screen can be provided through sequential operations as illustrated in FIG. 12. In operation of S600, the moving picture contents stored on the contents storing unit 110 are separated into multiple unit story-based moving pictures based on the content of the moving picture contents through performing a certain editing activity. In operation of S610, the separated unit story-based moving pictures are combined into one consecutive representative moving picture for each of the moving picture contents. In operation of S620, a list of the requested moving picture contents can be displayed on one screen by using the representative moving pictures for the respective moving picture contents.

Referring again to FIG. 11, after the initial screen is provided, in operation of S540, the VOD client selects the representative moving picture of the specific moving picture content.

Then, in operation of S560, the VOD service system 100 receives the selection of the corresponding representative moving picture, and provides a detailed screen displaying detailed contents information of the selected representative moving picture in operation of S580.

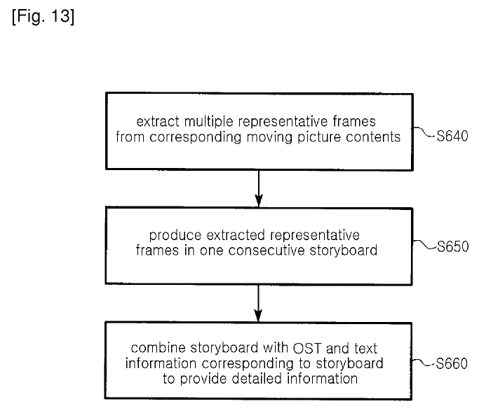

As illustrated in FIG. 13, the detailed screen is provided by performing sequential operations as follows. In operation of S640, a plurality of representative frames are extracted for each moving picture content. In operation of S650, a predetermined number of the representative frames are selected among the extracted representative frames and combined together to be produced in one consecutive storyboard. In operation of S660, the produced storyboard and OST and text information corresponding to the storyboard are combined with each other to produce the detailed screen.

It will be apparent to those skilled in the art that various modifications and variations can be made in the present invention. Thus, it is intended that the present invention covers the modifications and variations of this invention provided they come within the scope of the appended claims and their equivalents.

1. A VOD (voice on demand) service system comprising:
a transmitting unit receiving a VOD service request from a VOD client and transmitting data corresponding to the request to the VOD client through a network;
a contents storing unit storing moving picture contents to be provided;
a contents producing unit producing representative moving pictures each for the corresponding moving picture content stored on the contents storing unit and configuring an initial screen obtained by combining the representative moving pictures together; and
a controlling unit transmitting the initial screen including the representative moving pictures of the individual moving picture contents produced at the contents producing unit when the VOD client makes a request to provide a list of the moving picture contents to be provided through the transmitting unit.

2. The VOD service system of claim 1, wherein the contents producing unit comprises:
a moving picture processing unit separating the moving picture contents into multiple unit story-based moving pictures based on the content of the moving picture contents and combining the separated unit story-based moving pictures into one representative moving picture for each of the moving picture contents; and
an initial screen configuring unit outputting a list of the moving picture contents to be provided on one screen using the representative moving pictures produced at the moving picture processing unit.

3. The VOD service system of claim 2, wherein the moving picture processing unit comprises:
a unit story-based moving picture separating unit separating moving picture data into multiple unit story-based moving pictures based on the content of the moving picture data; and
a representative moving picture combining unit combining the separated unit story-based moving pictures into one consecutive moving picture for each of the moving picture contents.

4. The VOD service system of claim 2, wherein the contents producing unit further comprises:
a frame processing unit extracting multiple representative frames from the corresponding moving picture content and producing one storyboard; and
a contents content unit providing a detailed screen displaying the storyboard produced at the frame processing block.

5. The VOD service system of claim 4, wherein the frame processing unit comprises:
a representative frame extracting unit extracting multiple representative frames from the corresponding moving picture content and selecting a predetermined number of the representative frames among the extracted representative frames; and
a storyboard producing unit connecting the selected representative frames in predetermined spatial and temporal order to produce one storyboard.

6. The VOD service system of claim 4, wherein the contents content unit comprises an OST (original sound track) related to the corresponding moving picture content on the detailed screen.

7. The VOD service system of claims 4, wherein the contents content unit comprises text information on the corresponding moving picture content on the detailed screen.

8. A method for providing contents information in a VOD service, the method comprising the steps of:
receiving a list of moving picture contents to be provided from a VOD client;
providing an initial screen displaying representative moving pictures each for the corresponding moving picture content to the VOD client;
receiving a selection of the specific representative moving picture on the initial screen from the VOD client; and
providing a detailed screen displaying detailed contents information on the selected specific representative moving picture.

9. The method of claim 8, wherein the step of proving the initial screen comprising the steps of:
separating the moving picture contents into multiple unit story-based moving pictures;
combining the separated unit story-based moving pictures into one consecutive representative moving picture for each of the moving picture contents; and
outputting a list of the moving picture contents each represented in one consecutive representative moving picture on one screen.

10. The method of claim 8, wherein the step of proving the detailed screen comprises the steps of:
extracting multiple representative frames from the corresponding moving picture content; and
providing a storyboard that repetitively playing the extracted representative frames in predetermined spatial and temporal order.

11. The method of claim 10, wherein the step of providing the detailed screen further comprising the step of playing an OST related to the corresponding moving picture content.

12. The method of claim 10, wherein the step of providing the detailed screen further comprising the step of providing text information on the corresponding moving picture content to the VOD client.
